(19) United States
(12) Patent Application Publication
(10) Pub. No.: US 2003/0046698 A1
(43) Pub. Date: Mar. 6, 2003

(54) Methods and apparatuses for conducting a TV EPG search in various search time periods

(76) Inventors: Yakov Kamen, Cupertino, CA (US); Dan Kikinis, Saratoga, CA (US); Brian Kimball, Los Gatos, CA (US)

Correspondence Address: Thomas A. Van Zandt, Blakely, Sokoloff, Taylor & Zafman LLP, Seventh Floor, 12400 Wilshire Boulevard, Los Angeles, CA, 90025-1030, US

(21) Appl. No.: 10/166,810

(22) Filed: Jun. 10, 2002

Related U.S. Application Data
(60) Provisional application No. 60/297,587, filed on Jun. 11, 2001.

(51) Int. Cl. G06F 3/00; H04N 5/445; G06F 13/00

(52) U.S. Cl. 725/53; 725/39; 725/45

(57) ABSTRACT

An embodiment of the present invention provides a television electronic programming guide (EPG) that allow users to combine multiple search criteria within a single search. The EPG receives a television program search criteria set containing a plurality of search criteria and a specified search time period. The EPG provides a search result set containing television programs that meet the television program search criteria set for the specified search time period. The search time period may be revised such that the search criteria set is automatically applied to the revised search time period. One embodiment provides a search time period button that returns the search to a current time period from a specified future time period.

### CLAIM OF PRIORITY

This application is a continuation-in-part of U.S. application Ser. No.______, filed on May 31, 2002, entitled “METHOD FOR MAKING SELECTIONS IN SEARCH CRITERIA IN TV EPGs” and claims the benefit of the filing date of U.S. Provisional Application No. 60/297,587, filed Jun. 11, 2001 and is hereby incorporated by reference.

### FIELD OF THE INVENTION

Embodiments of the present invention relate generally to onscreen television program guides and more specifically to a method for changing an EPG search time period while maintaining an EPG search.

### BACKGROUND OF THE INVENTION

Onscreen television programming guides commonly referred to as electronic programming guides (EPGs) provide a user with the ability to create a search of available television programs that presents a specified subset of the available programs. The search may return available programs in a specified area of interest (e.g., comedies), or may return programs available from a specified broadcast station or programs available at a specified time, for example.

FIG. 1 illustrates aspects of an EPG display in accordance with the prior art. EPG display 100 includes a search criteria window 120. EPG display 101 includes a search result window 130. Typically, a user will enter search criteria on one display (e.g., EPG display 100), and view the search results on a following display (e.g., EPG display 101).

Typically, EPGs maintain an operating convention that selecting the left or right arrow moves a selection marker, such as a pointer or highlighter, in the time selection domain. Time navigation bar 110 includes left navigation arrow 111 and right navigation arrow 112, which are used to specify a search time.

For example, as shown in EPG display 100, the search criterion “Children” has been selected from the search criteria window 120. The EPG search is conducted based upon the specified criteria, and the result is displayed on a subsequent EPG display. For example, search result window 130 displays the station number and title of all children programs available. The user may then select a desired program. Typically, up and down arrows 131 and 132 are used to move a selection marker, such as a pointer or highlight, in the channel or programming selection domain.

The prior EPG presents the drawback in that if a user desires to change or refine the search criteria, the user must return to a previous screen and reset the search criteria. The new search is then conducted against the entire set of available programs. Another drawback is that present EPGs do not allow a search based upon the combination of multiple search criteria.

A further convention, typically maintained in prior art EPGs is that entering numbers from a TV remote control device causes the selection marker to jump to the TV channel whose number corresponds to the number entered on the remote control device.

However, if a search is refined, the number of presented items is already limited, so being able to enter a channel number to navigate to a selection does not present any advantage. Furthermore, a specific channel may or may not be represented in a specific search result, so jumping to a channel number entered by the user may not lead to an item in the search result, and hence may be counterproductive in the search.

An additional drawback of current EPG search mechanisms is that changing the search time period often requires instituting a new search. For example, a user may institute a program search for a time period several days in the future. For example, a user may be in a time period of one, two, or three days in the future, or may even wish to search for programs a week in the future. Typically, in such cases, the EPG cannot return to a current or previous search time period and maintain the search. In particular, when a user has instituted a search using a specific search criterion, in order to move from a search of one time period (e.g., future time period) to a search in another time period (e.g., current time period) the user may have to terminate the search and institute a new search (reenter the search criterion). Changing search time periods may even require the user to exit from the EPG and re-enter it.

### SUMMARY

Embodiments of the present invention provide methods and apparatuses to allow a user to create a television program search based upon selected criteria for a specified search time period, and revise the search time period such that the television program search is conducted for the revised time period automatically. For one embodiment, an electronic program guide receives a television program search criteria set containing a plurality of search criteria, and a specified search time period. The electronic program guide then provides a search result set containing television programs that meet the television program search criteria set and correspond to the specified search time. Upon receiving a revision to the specified search time period, the electronic program guide provides a revised search result set, containing television programs that meet the television program search criteria set, that corresponds to the revised search time period.

Other features and advantages of the present invention will be apparent from the accompanying drawings, and from the detailed description, that follows below.

### BRIEF DESCRIPTION OF THE DRAWINGS

Embodiments of the present invention are illustrated by way of example, and not limitation, by the figures of the accompanying drawings in which like references indicate similar elements and in which:

FIG. 1 illustrates aspects of an EPG display in accordance with the prior art;

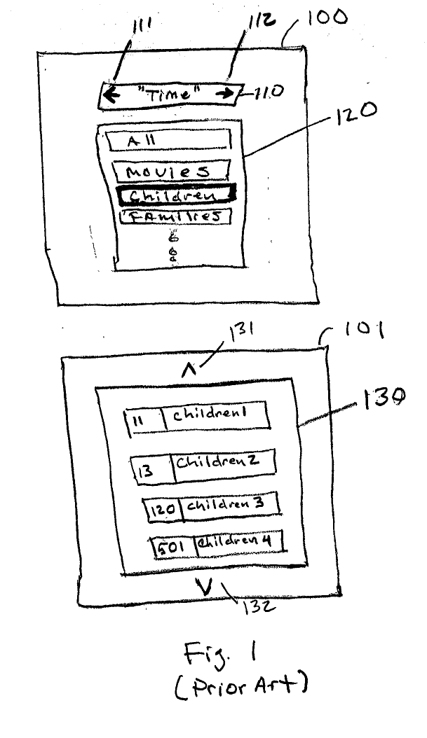

FIG. 2 illustrates aspects of a television electronic programming guide (EPG) in accordance with one embodiment of the present invention;

FIG. 3 illustrates a simplified block diagram of an exemplary television system for use with one embodiment of the present invention; and

FIG. 4 is a process flow diagram of a process in accordance with one embodiment of the present invention.

### DETAILED DESCRIPTION

An embodiment of the present invention provides a television electronic programming guide that allows users to change search time periods while maintaining a current search. For one embodiment, a single button, either a soft button on the screen or a hard button on the TV remote control, may be used to return the search to a current time period from a future time period without resetting other search parameters or resetting the search or the EPG. For alternative embodiments, other search time periods such as prime time, night time, etc., may be selected. Alternatively, or additionally the duration of the search time period may be selected as well by pushing a specific key or button.

In the following detailed description of exemplary embodiments of the present invention, numerous specific details are set forth in order to provide a thorough understanding of the described embodiments of the present invention. However, it will be apparent to one skilled in the art that alternative embodiments of the present invention may be practiced without these specific details. In some instances, well-known structures and devices are shown in block diagram form, rather than in detail, in order to avoid obscuring the description of exemplary embodiments of the present invention.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

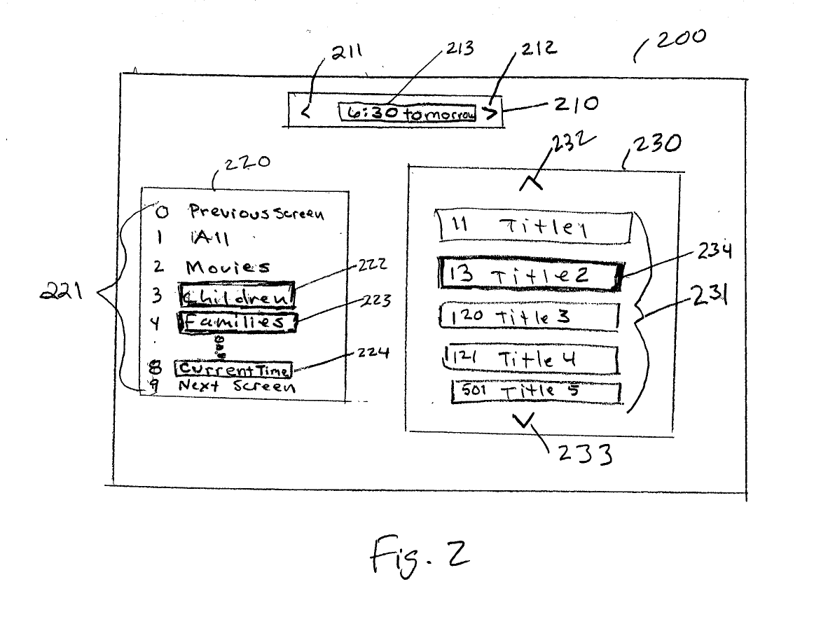

FIG. 2 illustrates aspects of a television electronic programming guide (EPG) in accordance with one embodiment of the present invention. EPG display 200 includes time navigation bar 210. Typically, EPGs maintain an operating convention that selecting the left or right arrow moves a selection marker, such as a pointer or highlighter, in the time selection domain. Time navigation bar 210 includes left navigation arrow 211 and right navigation arrow 212, which are used to specify a search time period 213. For example, as shown the search time period selected is “6:30 tomorrow”. Future time periods may be designated by days of the week, dates, or other indicative titles.

EPG display 200 also includes a search criteria window 220 containing a search criteria set 221. In one embodiment, each criterion is represented by a corresponding single digit. One or more of the search criteria may be selected to create a specific search. For example, selection markers highlight elements 222 and 223, which are elements 3 and 4, respectively, of search criteria set 231. The resulting search will be a combination of search criteria 3, Children, and search criteria 4, Family. For one embodiment the combination results in a Boolean “AND” operation for the selected search criteria. The selection of one or more search criteria from search criteria set 221 of search criteria window 220 and initiation of a search after criteria selection is finished may be implemented in various ways as known in the art. For one embodiment, the selection is preformed using a preprogrammed television remote control device.

The EPG display 200 also contains search result window 230 that displays a search result set 231. Search result set 231 contains the channel number and program name for programs meeting the selected search criteria. Program selection marker arrows 232 and 233 allow the user to move a program selection marker up and down, respectively, within the search result set 231. For example, search result 234 is a channel program listing, which in this example is channel 13, highlighted by the program selection marker. Once the selection marker comes to the bottom or the top of the screen, the list may scroll over to a following page of search results. In alternative embodiments, a page up/page down function can also be used to scroll to the next or previous page of search results.

For one embodiment, each of the desired search criteria can be selected by pressing a single button on a TV remote control device. One or more search criteria may be selected, thus allowing the user to enter the equivalent of a combined complex search without having to deal with the complexity of entering parameters and arguments of the search. For example, a user may create a Boolean search for search criteria Children and Family by pressing the number 3 key and the number 4 key on a TV remote control device. For one embodiment, a selected search criteria may be deselected by depressing the corresponding numbered key of the TV remote control device.

Upon the dynamic selection (or deselection) of search criteria, the search result set 231 is updated to reflect the current search parameters.

For one embodiment, the search criteria set 231 is displayed on multiple screens by allowing overflow of the criteria list onto “previous” or “next” screens. For example, using the number 9 key to go to the next screen and the number 0 key to return to the previous screen, allows a user to have access to a large selection of program search criteria.

Additionally, as shown, an “All” selection may be included in search criteria set 221. Selection of “All” would result in a search by time parameter 213 of all programming criteria. For alternative embodiments, an “All” selection may be included in a channel or program search domain, rather than in a time search domain.

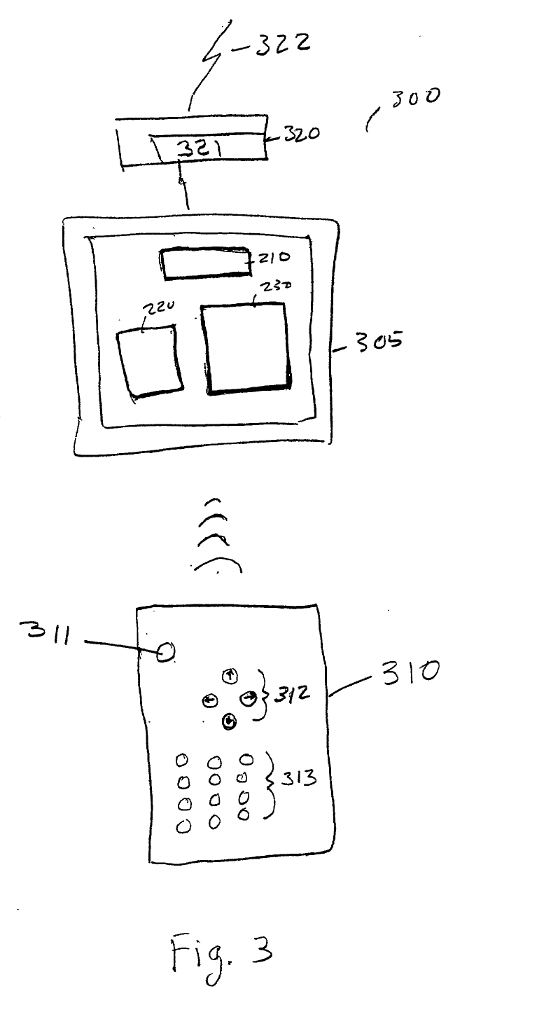

EPG display 200 also includes a search time period button 224 (labeled “current time”) that corresponds to element 8 of the search criteria set 231. In alternative embodiments, the search time period button may be a dedicated button on a push-button remote control device. For example, time bar 213 shows a search in the future (e.g., tomorrow). To return the search time period to the current date and time, the user selects the search time period button 224, which acts as a current time period button. For example the user would select element 8 of search criteria set 221. All other currently selected search criteria (e.g., elements 3 and 4) would continue to be selected. Selecting the current time button (i.e., search time period button 224) would change the search time period to the current time. The search time period displayed in time bar 213 (i.e., 6:30 tomorrow) would be automatically deselected and time bar 213 would be set to the current time. For an alternative embodiment, as described below in reference to FIG. 3, the search time period button may be implemented as a dedicated button on a remote control device. If the current button on a remote is depressed when the EPG is not engaged in a search, program selection, or other programming guide functions, the current time button may be used to display the current time on the television screen

For alternative embodiments, the current time button function may be assigned to one of the programmable buttons that are available on some remote controls today or may be implemented as a macro or a combination of keys that can be combined to create a current time button.

As described above, pressing the current time button 224 changes the search time period from a future search time period to the current time. For alternative embodiments, a second pressing of the current time button 224 may change the search time period to a different time period. One or more time intervals may be defined, allowing quick changes to the specified search time periods with successive depressions of the current time button 224. The current time button 224 may therefore be viewed as a change search time button for these various alternative embodiments. Time intervals that may be defined include for example, prime time, which may be 7 p.m. or 8 p.m., or nighttime (e.g., 11 p.m.). For an embodiment in which such time intervals were defined, if a user were watching television just before 4 p.m., then first depression of current time button 224 would return the search time period to a time slot of 3:30 p.m., for example. A subsequent depression would change the search time period to 7 p.m. (prime time) and another would change the search time period to 11 p.m. (nighttime). Alternatively, the time search period function might be incremented by a fixed amount of time (e.g., two hours) upon depression of a change search time button. The search time period could be incremented until a specified time (e.g., 11:00 p.m.) and then return to the current time. The programming of such a variable time search mechanism may be accomplished by methods known in the art.

FIG. 3 illustrates a simplified block diagram of an exemplary television system for use with one embodiment of the present invention. System 300, shown in FIG. 3, includes a television set 305 coupled to set-top box 320. Set-top box 320 may typically contain a processor and memory, the memory having software 321 stored upon it for implementing the present invention. Network connection 322 may be analog or digital cable, fiber optic, digital subscriber line (DSL), aerial, wireless cable, fiber, local multi-channel distribution systems (LMDS), etc., all of which are well-known in the art. System 300 also includes remote control 310, typically controlling the set-top box 320. Remote control 310 has standard navigational buttons 312 and standard number buttons 313. Remote control 310 also includes a dedicated current time button 311. Remote control 310 may also include other buttons not shown.

In alternative embodiments, remote control 310 may be integrated with a TV, VCR, DVD player, or other presentation devices or combinations thereof.

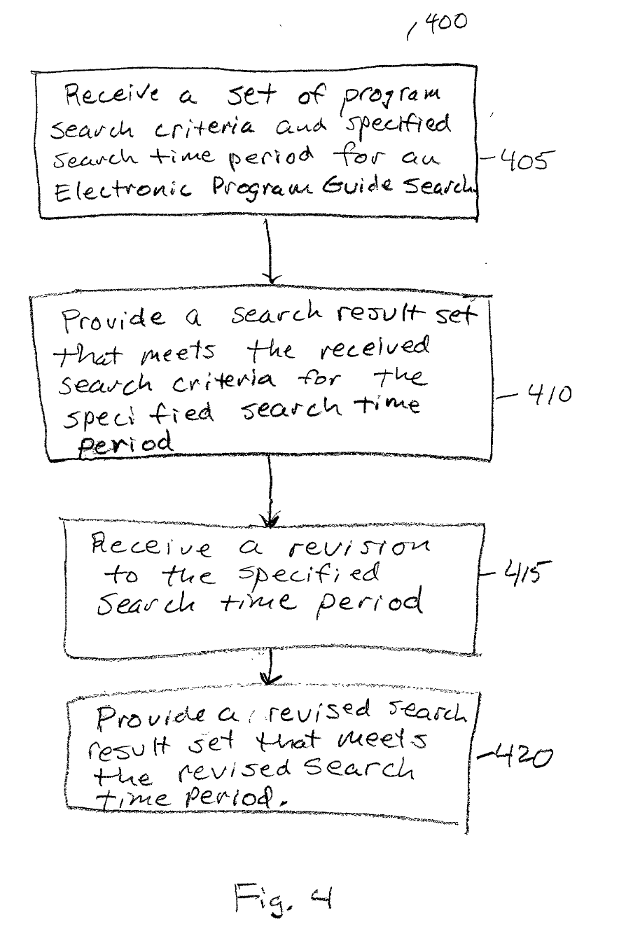

FIG. 4 is a process flow diagram of a process in accordance with one embodiment of the present invention. Process 400 begins at operation 405 in which an EPG receives one or more search criteria and a specified search time period. The search time period is the time period over which the search will be conducted. For example, the search time period may be several days in the future. The search criteria may be selected as described above in reference to FIG. 2. If more than one search criteria is received, the search criteria are combined. For example, in one embodiment the search criteria are combined using a Boolean “AND” operation to provide search results that meet all of the search criteria. In alternative embodiments, the search criteria may be combined in other ways.

At operation 410, the EPG provides a search result set. The search result set contains all of the programs that meet the search criteria received at operation 405 for the specified search time period.

At operation 415, the EPG receives a revision to the specified search time period. For example, the user may wish to search the current time period instead of a future time period. The user presses the current time button (or change search time period button) as described above. The EPG then searches the current time period or whichever time period is specified by the revision, using the received search criteria.

At operation 420 the search result set is revised to reflect the revised search time period. That is the EPG applies the same received search criteria to the new specified search time period. The search result set from the original search is modified to reflect the change in search time period.

Thus, one embodiment of the present invention provides a method by which a user may change the search time period of an EPG search without resetting the EPG search and without resetting other search parameters.

The operations described above in reference to FIG. 4 (receiving EPG search criteria, including a search time period, providing a search result set, receiving a revision of the search time period, and providing an updated search result set) may be implemented by hardware and/or software contained within the viewer's set-top box 320. For example, a set-top box may include one or more processors that can execute code or instructions stored within a machine-readable medium that may also be included within the set-top box.

The machine-readable medium may include a mechanism that provides (i.e., stores and/or transmits) information in a form readable by a machine such as computer or digital processing device. For example, a machine-readable medium may include a read only memory (ROM), random access memory (RAM), magnetic disk storage media, optical storage media or flash memory devices. The code or instructions may be represented by carrier-wave signals, infrared signals, digital signals, and by other like signals.

While the invention has been described in terms of several embodiments, those skilled in the art will recognize the invention is not limited to the embodiments described, but can be practiced with modification and alteration within the spirit and scope of the appended claims. The description is thus to be regarded as illustrative instead of limiting.

What is claimed is:

1. A method comprising:
receiving a television program search criteria set containing a plurality of search criteria;
receiving a specified search time period; and
providing a search result set containing television programs that meet the television program search criteria set and correspond to the specified search time.

2. The method of claim 1 further comprising:
receiving a revision to the specified search time period; and
providing a revised search result set containing television programs that meet the television program search criteria set, the revised search result set corresponding to the revised search time period.

3. The method of claim 2, wherein the specified search time period is a future time period and the revised specified search time period is a current time period.

4. The method of claim 2, wherein the revised search time period is selected from a plurality of available search time periods.

5. The method of claim 3, wherein the television program search is directed to the current time by pressing a corresponding button on a push-button control device.

6. An onscreen television program guide comprising:
a search criteria window containing a plurality of search criteria, each criterion corresponding to a set of television programs, each criterion capable of being selected for a search such that two or more selected criteria form a search criteria set;
a search time period window to display a specified search time period; and
a search result window to display a list of television programs corresponding to the search criteria set and the specified search time period.

7. The onscreen television program guide of claim 6, further comprising a search time period button such that depressing the button will direct the search to a new search time period other than the specified search time period.

8. The onscreen television program guide of claim 7, wherein the new search time period is the current time and the specified search time period is a future time.

9. The onscreen television program guide of claim 7, wherein depressing the search time period button a specified number of times will direct the search to one of a plurality of available search time periods, each search time period corresponding to one of the specified number of times the search time period is depressed.

10. A machine-readable medium containing instructions which, when executed by a processor, cause the processor to perform a method, the method comprising:
receiving a television program search criteria set containing a plurality of search criteria;
receiving a specified search time period; and
providing a search result set containing television programs that meet the television program search criteria set and correspond to the specified search time.

11. The machine-readable medium of claim 10, wherein the method further comprises:
receiving a revision to the specified search time period; and
providing a revised search result set containing television programs that meet the television program search criteria set, the revised search result set corresponding to the revised search time period.

12. The machine-readable medium of claim 11, wherein the specified search time period is a future time period and the revised specified search time period is a current time period.

13. The machine-readable medium of claim 11, wherein the revised search time period is selected from a plurality of available search time periods.

14. The machine-readable medium of claim 12, wherein the television program search is directed to the current time by pressing a corresponding button on a push-button control device.

15. An apparatus comprising:
a processor having a memory coupled thereto, the memory having stored thereon executable instructions which when executed by the processor, cause the processor to receive a television program search criteria set containing a plurality of search criteria, receive a specified search time period, and provide a search result set containing television programs that meet the television program search criteria set and correspond to the specified search time.

16. The apparatus of claim 15, wherein the executable instructions when executed by the processor, further cause the processor to receive a revision to the specified search time period, and provide a revised search result set containing television programs that meet the television program search criteria set, the revised search result set corresponding to the revised search time period.

17. A system comprising:
a television display screen;
an electronic program guide capable of being displayed on the television display screen, the electronic program guide having a search criteria window containing a plurality of search criteria that may be specified to form a television program search;
a search result window to display a list of television programs, the list of television programs corresponding to the search criteria set and a specified search time period; and
a push-button control device to dynamically revise the search time period such that the search result window displays a revised list of television programs, the list of television programs corresponding to the search criteria set and to the revised search time period.

18. The system of claim 17, wherein the specified search time period is a future time period and the revised search time period is a current time period.

19. The system of claim 18, wherein the revised search time period is selected from a plurality of available search time periods.

20. The system of claim 19, wherein each of the plurality of available search times is selected by depressing the push-button control device a specified number of times.
